(19) United States
(12) Patent Application Publication
(10) Pub. No.: US 2025/0058286 A1
(43) Pub. Date: Feb. 20, 2025

(54) MOISTURE-PERMEABLE COMPOSITE MEMBRANE AND METHOD FOR MANUFACTURING THE SAME

(71) Applicant: G-FUN INDUSTRIAL CORPORATION, Taoyuan City (TW)

(72) Inventors: Kuo-Chin CHEN, New Taipei City (TW); Sung-Yun HUANG, New Taipei City (TW); Li-Hsun CHANG, New Taipei City (TW); Chia-Lin CHEN, New Taipei City (TW); Shu-Ling LIN, New Taipei City (TW); Yu-Ping CHUANG, New Taipei City (TW)

(21) Appl. No.: 18/403,899

(22) Filed: Jan. 4, 2024

(30) Foreign Application Priority Data
Aug. 18, 2023 (TW) 112131185

(51) Int. Cl. B01D 71/54; C08G 69/44

(52) U.S. Cl. CPC B01D 71/54; C08G 69/44; B01D 2323/081; B01D 2323/30; B01D 2323/64

(57) ABSTRACT

A moisture-permeable composite membrane is manufactured by the step of subjecting a mixture to a crosslinking treatment. The mixture contains a polyisoprene, a polyurethane with a polar functional group, a crosslinking agent, and a vulcanizing agent. In the mixture, a weight ratio of the polyurethane with the polar functional group to the polyisoprene ranges from 1:0.55 to 1:6.60. A method for manufacturing the moisture-permeable composite membrane is also provided.

### CROSS-REFERENCE TO RELATED APPLICATION

This application claims priority to Taiwanese Invention patent application No. 112131185, filed on Aug. 18, 2023, and incorporated by reference herein in its entirety.

### FIELD

The present disclosure relates to a composite membrane, and more particularly to a moisture-permeable composite membrane. The present disclosure also relates to a method for manufacturing the moisture-permeable composite membrane.

### BACKGROUND

Waterproof and breathable textiles made from petrochemical raw materials provide micro-elasticity and waterproofing. However, such textiles often fall short in providing the necessary elasticity and stretch required for comfortable daily wear over extended periods. The petrochemical raw materials are non-renewable raw materials. If the petrochemical raw materials can be substituted with biomass materials, the use of the petrochemical raw materials can be greatly reduced. In addition to reducing the consumption of the petrochemical raw materials, greenhouse gas emissions from petrochemical production can also be reduced.

On the other hand, raw materials obtained from natural rubber trees lack moisture permeability and may trigger allergic reactions in some individuals due to the presence of proteins.

In spite of the aforesaid, there is still a need to develop a moisture-permeable composite membrane that has excellent stretchability and moisture permeability.

### SUMMARY

Therefore, an object of the present disclosure is to provide a moisture-permeable composite membrane and a method for manufacturing the moisture-permeable composite membrane, which can alleviate at least one of the drawbacks of the prior art.

According to one aspect of the present disclosure, the moisture-permeable composite membrane is manufactured by the step of subjecting a mixture to a crosslinking treatment. The mixture contains a polyisoprene, a polyurethane with a polar functional group, a crosslinking agent, and a vulcanizing agent. In the mixture, a weight ratio of the polyurethane with the polar functional group to the polyisoprene ranges from 1:0.55 to 1:6.60.

According to another aspect of the present disclosure, the method for manufacturing the aforesaid moisture-permeable composite membrane includes:
(a) mixing a polyisoprene and a polyurethane with a polar functional group, so as to obtain a premix, a weight ratio of the polyurethane with the polar functional group to the polyisoprene ranging from 1:0.55 to 1:6.60;
(b) blending the premix with a crosslinking agent and a vulcanizing agent, so as to obtain a mixture;
(c) applying the mixture to a release substrate, so as to form a preformed film on the release substrate; and
(d) subjecting the release substrate to a drying treatment to allow the preformed film to undergo a crosslinking reaction, so as to obtain the moisture-permeable composite membrane.

### DETAILED DESCRIPTION

For the purpose of this specification, it will be clearly understood that the word “comprising” means “including but not limited to”, and that the word “comprises” has a corresponding meaning.

It is to be understood that, if any prior art publication is referred to herein, such reference does not constitute an admission that the publication forms a part of the common general knowledge in the art, in Taiwan or any other country.

Unless defined otherwise, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

The present disclosure provides a moisture-permeable composite membrane, which is manufactured by the step of subjecting a mixture to a crosslinking treatment. The mixture contains a polyisoprene, a polyurethane with a polar functional group, a crosslinking agent, and a vulcanizing agent. In the mixture, a weight ratio of the polyurethane with the polar functional group to the polyisoprene ranges from 1:0.55 to 1:6.60.

In certain embodiments, the weight ratio of the polyurethane with the polar functional group to the polyisoprene ranges from 1:0.66 to 1:3.03.

In certain embodiments, the polyisoprene has a biomass content not lower than 20%.

In certain embodiments, the polar functional group is selected from the group consisting of a carboxyl group, a sulfonic acid group, an ammonium group, a hydroxymethyl group, and combinations thereof.

In certain embodiments, the crosslinking agent is selected from the group consisting of an isocyanate-based crosslinking agent, an oxazoline-based crosslinking agent, a polyethylenimine-based crosslinking agent, a carbodiimide-based crosslinking agent, and an epoxy-based crosslinking agent.

In certain embodiments, the vulcanizing agent is selected from the group consisting of a sulfinylamine-based vulcanizing agent, a thiuram-based vulcanizing agent and a dithiocarbamate-based vulcanizing agent.

According to the present disclosure, the crosslinking agent is present in an amount ranging from 0.5 wt % to 4.0 wt %, based on the total weight of the mixture. In certain embodiments, the crosslinking agent is present in an amount ranging from 0.5 wt % to 3.0 wt %, based on the total weight of the mixture. In other embodiments, the crosslinking agent is present in an amount ranging from 0.5 wt % to 1.5 wt %, based on the total weight of the mixture.

According to the present disclosure, the vulcanizing agent is present in an amount ranging from 2.0 wt % to 8.0 wt %, based on the total weight of the mixture. In certain embodiments, the vulcanizing agent is present in an amount ranging from 4.0 wt % to 8.0 wt %, based on the total weight of the mixture. In other embodiments, the vulcanizing agent is present in an amount ranging from 4.0 wt % to 6.0 wt %, based on the total weight of the mixture.

In certain embodiments, the mixture further includes water.

The present disclosure also provides a method for manufacturing a moisture-permeable composite membrane which includes the following steps (a) to (d).

In step (a), a polyisoprene is mixed with a polyurethane with a polar functional group, so as to obtain a premix. A weight ratio of the polyurethane with the polar functional group to the polyisoprene ranges from 1:0.55 to 1:6.60.

In step (b), the premix is blended with a crosslinking agent and a vulcanizing agent, so as to obtain a mixture.

In step (c), the mixture is applied to a release substrate, so as to form a preformed film on the release substrate.

In step (d), the release substrate is subjected to a drying treatment to allow the preformed film to undergo a crosslinking reaction, so as to obtain the moisture-permeable composite membrane.

In certain embodiments, in step (d), the drying treatment is conducted at a temperature ranging from 60° C. to 140° C.

In certain embodiments, the method further includes, after performing step (b) and before performing step (c), step (c′) of subjecting the mixture obtained in step (b) to a filtration treatment to remove agglomerates thereof.

The disclosure will be further described by way of the following examples. However, it should be understood that the following examples are solely intended for the purpose of illustration and should not be construed as limiting the disclosure in practice.

### EXAMPLES

### Example 1 (EX1)

A polyurethane with a carboxyl group (Manufacturer: Shuang-Bang Industrial Corp., Cat. no. WS-1795, solid content: 20%, viscosity: 200 cps to 400 cps, weight average molecular weight: 2000 g/mol to 4000 g/mol) and a polyisoprene (Manufacturer: Yulex, Cat. no. Yulex Pure, solid content: not lower than 60%, biomass content: 25%, protein content: not greater than 100 μg/g, pH value: 10 to 12) were uniformly mixed at a weight ratio of 1:3.03 by a stirring treatment conducted at a stirring speed of 250 rpm, so as to obtain a premix. While stirring, a crosslinking agent, a vulcanizing agent, water, and other auxiliary agents were uniformly blended into the premix, followed by subjecting the thus obtained mixture to a filtration treatment with a 200-mesh filter to remove agglomerates thereof. The ingredients used for blending with the premix and the amounts thereof are summarized in Table 1 below.

TABLE 1

| | | | Amount (wt %) |
|---|---|---|---|
| | | | (Based on the total |
| Ingredient | | | weight of the mixture) |
| Crosslinking | | Non-ionic blocked aromatic | 1.20 |
| agent | | isocyanate (Manufacturer: | |
| | | Kuseng, Cat. no. Agent D, solid | |
| | | content: approximately 30%, and | |
| | | NCO content: 3% to 30%) | |
| Vulcanizing | | Sulfinylamine | 4.70 |
| agent | | (Manufacturer: Bostex, Cat. no. | |
| | | Bostex 916, solid content: | |
| | | approximately 50%, pH value: 9 | |
| | | to 11, and viscosity: 1000 cps to | |
| | | 1500 cps) | |
| Water | | | 4.69 |
| Other | Stabilizing | Sulfated methyl oleate | 0.42 |
| auxiliary | agent | (Manufacturer: Akron, | |
| agents | | Cat. no. SMO) | |
| | Antioxidant | Wingstay ® L | 1.24 |
| | | (Manufacturer: Akron, Cat. | |
| | | no. Bostex 24) | |
| | Defoaming | Polysiloxane | 0.38 |
| | agent | (Manufacturer: BYK, Cat. no. | |
| | | BYK022) | |
| | Levelling | Alkoxylated fatty alcohol | 0.33 |
| | agent | (Manufacturer: BYK, Cat. no. | |
| | | BYK 800) | |
| | Anti-stick | Silicon dioxide | 2.82 |
| | agent | (Manufacturer: Evonik, Cat. no. | |
| | | OK412) | |

Next, the mixture was applied to a polyester fabric coated with a release agent (serving as a release substrate) by using a shim with a thickness of 0.15 mm, so as to form a preformed film with an approximate thickness of 0.1 mm on the release substrate. Thereafter, the release substrate was subjected to a drying treatment with a gradually increasing temperature from 60° C. to 140° C. at a heating rate of 40° C./min for 2 minutes so as to allow the preformed film to undergo a crosslinking reaction, followed by detaching the thus cross-linked preformed film from the release substrate, so as to obtain a moisture-permeable composite membrane of EX1.

### Examples 2 to 4 (EX2 to EX4)

The procedures for manufacturing the moisture-permeable composite membranes of EX2 to EX4 were similar to those of EX1, except that the weight ratios of the polyurethane with the carboxyl group to the polyisoprene were adjusted to 1:0.66, 1:1.00, and 1:1.50, respectively, so as to obtain the moisture-permeable composite membranes of EX2 to EX4.

### Comparative Example 1 (CE1)

The procedures for manufacturing the polyisoprene membrane of CE1 were similar to those of EX1, except that the polyurethane with the carboxyl group and the crosslinking agent were absent.

### Property Evaluation

### A. Measurement of Elongation

The moisture-permeable composite membrane of the respective one of EX1 to EX4 and the polyisoprene membrane of CE1 were subjected to determination of elongation using a tensile testing machine (Manufacturer: Instron; Model no.: 5565Q4982) in accordance with ASTM D5034 (published in 2021). The results are shown in Table 2 below.

### B. Measurement of Moisture Permeability

The moisture-permeable composite membrane of the respective one of EX1 to EX4 and the polyisoprene membrane of CE1 were subjected to determination of moisture permeability using a constant temperature and humidity testing machine (Manufacturer: YOUNG CHENN INSTRUMENTS CO., LTD.; Model no.: HG-50-R) in accordance with JIS L1099-B1 (published in 2021). The results are shown in Table 2 below.

### Results

TABLE 2

| | Elongation | Moisture permeability |
|---|---|---|
| | (%) | (g/m² · 24 h) |
| EX1 | 500 | 3500 |
| EX2 | 400 | 2500 |
| EX3 | 300 | 4000 |
| EX4 | 200 | 7000 |
| CE1 | 550 | 0 |

As shown in Table 2, the elongation determined in the moisture-permeable composite membrane of each of EX1 to EX4 and the polyisoprene membrane of CE1 were all not lower than 200%. The moisture permeability determined in the moisture-permeable composite membrane of each of EX1 to EX4 was all not lower than 2500 g/m2·24 h, whereas that of the polyisoprene membrane of CE1 was 0 g/m2·24 h. These results indicate that compared with the polyisoprene membrane of CE1, the moisture-permeable composite membrane of each of EX1 to EX4 can offer excellent moisture permeability while retaining substantial elongation.

In summary, it is clear that the moisture-permeable composite membrane manufactured by the method for manufacturing the moisture-permeable composite membrane of the present disclosure has excellent moisture permeability and stretchability. Moreover, the method for manufacturing the moisture-permeable composite membrane of the present disclosure does not require the use of hazardous organic solvents, and hence can effectively reduce the risk to humans and is environmentally friendly.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A moisture-permeable composite membrane manufactured by the step of:
subjecting a mixture to a crosslinking treatment, the mixture containing a polyisoprene, a polyurethane with a polar functional group, a crosslinking agent, and a vulcanizing agent,
wherein in the mixture, a weight ratio of the polyurethane with the polar functional group to the polyisoprene ranges from 1:0.55 to 1:6.60.

2. The moisture-permeable composite membrane according to claim 1, wherein the polyisoprene has a biomass content not lower than 20%.

3. The moisture-permeable composite membrane according to claim 1, wherein the polar functional group is selected from the group consisting of a carboxyl group, a sulfonic acid group, an ammonium group, a hydroxymethyl group, and combinations thereof.

4. The moisture-permeable composite membrane according to claim 1, wherein the crosslinking agent is selected from the group consisting of an isocyanate-based crosslinking agent, an oxazoline-based crosslinking agent, a polyethylenimine-based crosslinking agent, a carbodiimide-based crosslinking agent, and an epoxy-based crosslinking agent.

5. The moisture-permeable composite membrane according to claim 1, wherein the vulcanizing agent is selected from the group consisting of a sulfinylamine-based vulcanizing agent, a thiuram-based vulcanizing agent and a dithiocarbamate-based vulcanizing agent.

6. The moisture-permeable composite membrane according to claim 1, wherein the crosslinking agent is present in an amount ranging from 0.5 wt % to 4.0 wt %, based on the total weight of the mixture.

7. The moisture-permeable composite membrane according to claim 1, wherein the vulcanizing agent is present in an amount ranging from 2.0 wt % to 8.0 wt %, based on the total weight of the mixture.

8. The moisture-permeable composite membrane according to claim 1, wherein the mixture further includes water.

9. A method for manufacturing a moisture-permeable composite membrane, comprising:
(a) mixing a polyisoprene and a polyurethane with a polar functional group, so as to obtain a premix, a weight ratio of the polyurethane with the polar functional group to the polyisoprene ranging from 1:0.55 to 1:6.60;
(b) blending the premix with a crosslinking agent and a vulcanizing agent, so as to obtain a mixture;
(c) applying the mixture to a release substrate, so as to form a preformed film on the release substrate; and
(d) subjecting the release substrate to a drying treatment to allow the preformed film to undergo a crosslinking reaction, so as to obtain the moisture-permeable composite membrane.

10. The method according to claim 9, wherein in step (d), the drying treatment is conducted at a temperature ranging from 60° C. to 140° C.

11. The method according to claim 9, further comprising, after performing step (b) and before performing step (c), step (c′) of subjecting the mixture obtained in step (b) to a filtration treatment to remove agglomerates thereof.
